(19) United States
(12) Patent Application Publication
(10) Pub. No.: US 2006/0067562 A1
(43) Pub. Date: Mar. 30, 2006

(54) Detection of moving objects in a video

(75) Inventors: Chandrika Kamath, Tracy, CA (US); Sen-Ching S. Cheung, Lexington, KY (US)

Correspondence Address: Eddie E. Scott;Assistant Laboratory Counsel, Lawrence Livermore National Laboratory, P.O. Box 808, L-703, Livermore, CA, 94551, US

(73) Assignee: The Regents of the University of California

(21) Appl. No.: 11/234,563

(22) Filed: Sep. 23, 2005

Related U.S. Application Data
(60) Provisional application No. 60/615,441, filed on Sep. 30, 2004.

(51) Int. Cl. G06K 9/00

(52) U.S. Cl. 382/103

(57) ABSTRACT

A video camera produces a video sequence including moving objects. A computer is adapted to process the video sequence, produce individual frames, and use a fast-adapting background subtraction model to validate the results of a slow-adapting background subtraction model to improve identification of the moving objects.

### CROSS-REFERENCE TO RELATED APPLICATIONS

This application claims the benefit of U.S. Provisional Patent Application No. 60/615,441 filed Sep. 30, 2004 and titled “Robust Background Subtraction with Foreground Validation for Detection of Moving Objects in Video.” U.S. Provisional Patent Application No. 60/615,441 filed Sep. 30, 2004 and titled “Robust Background Subtraction with Foreground Validation for Detection of Moving Objects in Video” is incorporated herein by this reference.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to videos and more particularly to detection of moving objects in a video.

2. State of Technology

The article, “Robust Techniques for Background Subtraction in Urban Traffic Video,” by Sen-Ching S. Cheung and Chandrika Kamath, IS&T/SPIE's Symposium on Electronic Imaging San Jose, Calif., United States, Jan. 18, 2004 through Jan. 22, 2004 provides the following state of technology information, “Identifying moving objects from a video sequence is a fundamental and critical task in video surveillance, traffic monitoring and analysis, human detection and tracking, and gesture recognition in human-machine interface.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides a system for improving identification of moving objects in a video. One embodiment of the present invention comprises the steps of obtaining a video sequence that includes the objects and using a fast-adapting background subtraction model to validate the results of a slow-adapting background subtraction model to improve identification of the objects. Another embodiment of the present invention comprises the steps of obtaining a video sequence that includes the moving objects, and utilizing an algorithm which combines a slow-adapting background subtraction technique with a fast-adapting background subtraction technique to improve identification of the objects, wherein the said slow-adapting algorithm is the Kalman filter and the fast-adapting algorithm is the difference of consecutive frames of the video, and validating the results of the slow adapting algorithm by considering the moving object to be defined by the bounding ellipse around the object identified by the fast-adapting algorithm, and using the histograms of the object and the background to correctly identify moving objects which may be partially occluded. Another embodiment of the present invention comprises a video camera that produces a video sequence including the objects and a computer adapted to process said video sequence, produce individual frames, and use a fast-adapting background subtraction model to validate the results of a slow-adapting background subtraction model to improve identification of the objects.

The present invention is useful in improving video surveillance. The present invention is particularly useful in traffic monitoring and analysis. The present invention has many other uses including human detection and tracking, gesture recognition in human-machine interface, and other applications.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 is a flow diagram that illustrates one embodiment of a system for tracking moving objects in a video.

FIG. 2 illustrates the input frames.

FIG. 3 is a single frame of the video used to illustrate the moving objects.

FIG. 4 illustrates the moving objects found by a fast-adapting algorithm.

FIG. 5 illustrates the moving objects found by a slow-adapting algorithm.

FIG. 6 illustrates combined output from the slow- and fast-adapting algorithms that better identifies the moving objects.

FIG. 7 illustrates the data validation module.

FIG. 8 illustrates another embodiment of a system constructed in accordance with the present invention.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

The present invention improves identification of moving objects in a video sequence. The present invention has use in computer vision applications. Some examples of the applications include video surveillance, traffic monitoring and analysis, human detection and tracking, and gesture recognition in human-machine interface.

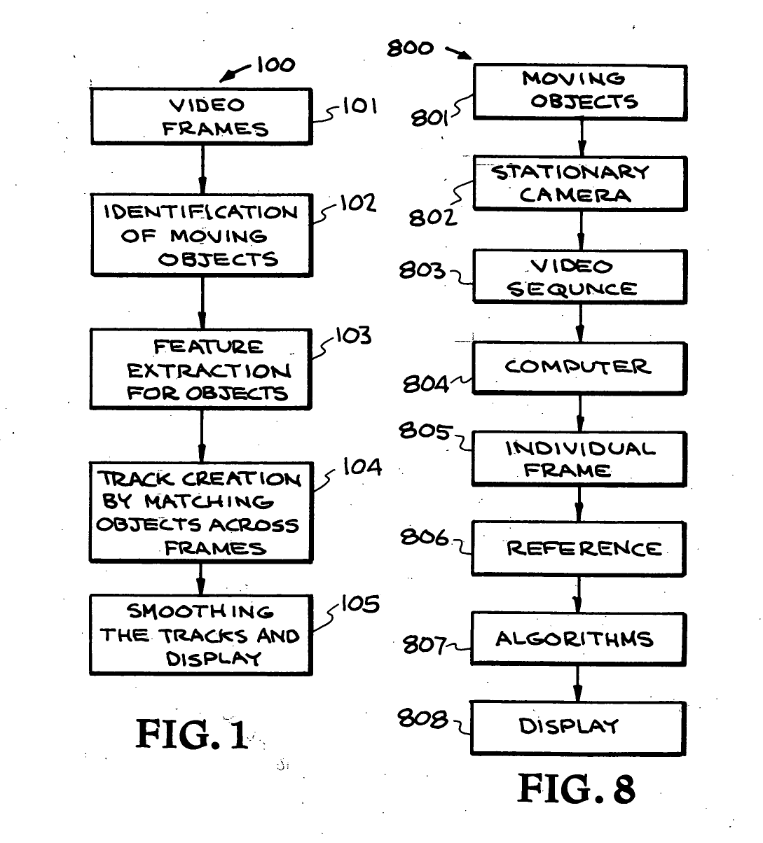

Referring now to FIGS. 1-7, an embodiment of a system constructed in accordance with the present invention is illustrated. The system is designated generally by the reference numeral 100. The system 100 provides a method of improving identification of moving objects in a video comprising the steps of obtaining a video sequence and utilizing a fast-adapting algorithm, a slow-adapting algorithm, and the input frame from the sequence to improve the identification of the moving objects. The video is composed of input frames. Identification of moving objects in a video sequence is traditionally done by background subtraction, where each video frame is compared against a reference or background model. The step of a fast-adapting algorithm for the background model builds a model which adapts quickly to changes in the video such as a change in illumination due to the shadow of a cloud. The step of a slow-adapting algorithm builds a background model which adapts slowly to such changes. The step of data validation combines these two models along with the input video frame for improved identification of the moving objects. The step of feature extraction finds features which represent the objects, such as its location, size, and color. These features are used to match an object in one frame to an object in the next frame, creating a track. Extraneous tracks, such as tracks that do not last long enough, are dropped from the final output.

The system 100 is a system for detecting and tracking vehicles in a surveillance video. The system 100 includes an algorithm that combines information from different background models to improve identification of moving objects. Pixels in the current frame that deviate significantly from the background are considered to be moving objects. Similar objects are associated between frames to yield coherent tracks. The entire process is automatic and uses computation time that scales according to the size of each frame in the input video sequence. The system 100 is useful in video surveillance, traffic monitoring and analysis, human detection and tracking, and gesture recognition in human-machine interface.

Referring now to FIG. 1, the system 100 for improving identification and tracking of moving objects in a video is illustrated in a flow diagram. The system 100 shown includes video frames 101, identification of moving objects 102, feature extraction for objects 103, track creation by matching across frames 104, and smoothing the tracks and display 105. The system 100 illustrated in FIG. 1 includes the steps of the input video frames 101, identification of moving objects 102, feature extraction for moving objects 103, track creation by matching the moving objects between frames 104, and smoothing the tracks and display 105. Referring now to FIG. 2, the input frames 101 are further illustrated. The input frames are designated by the reference numerals 201, 202, and 203.

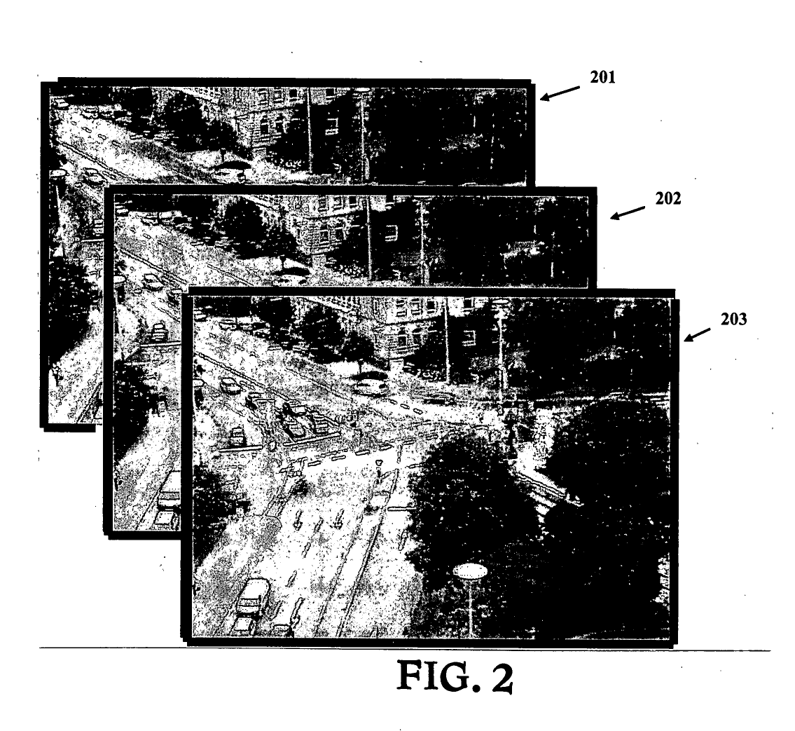

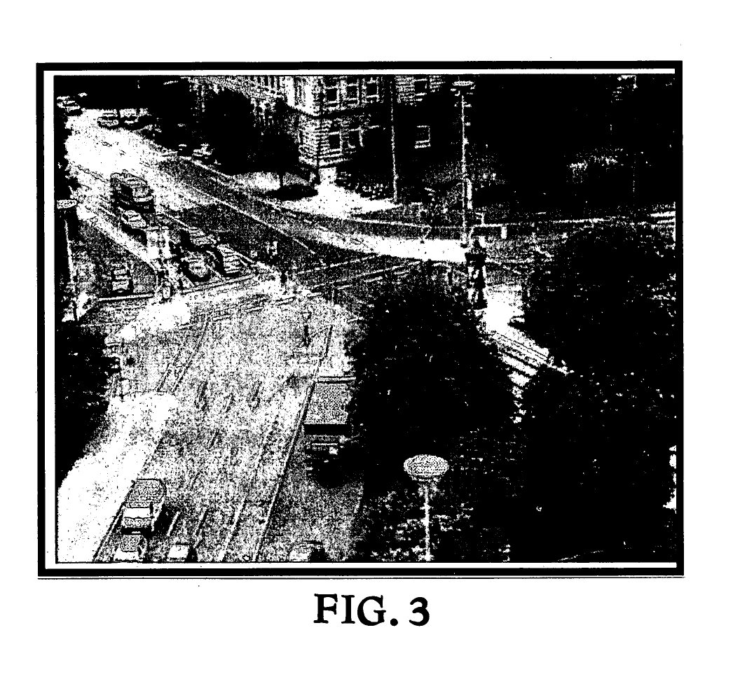

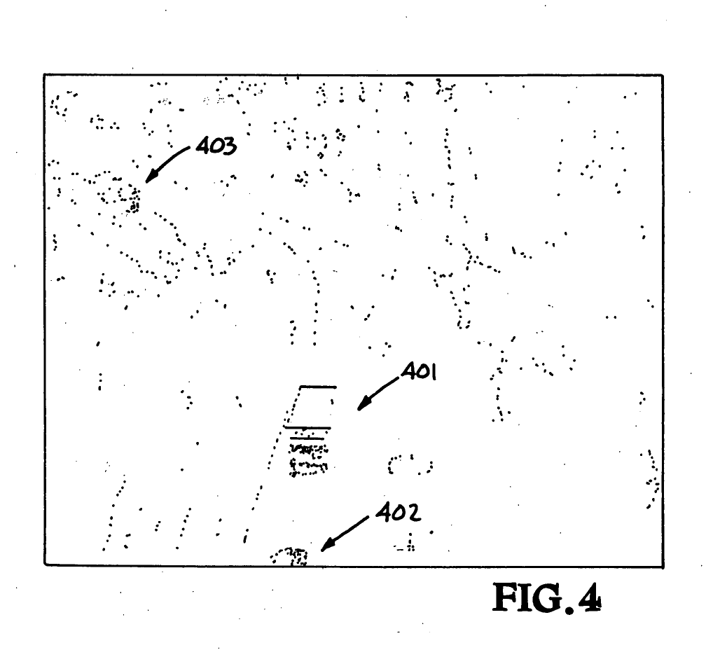

FIG. 3 is an illustration of a sample input frame 300 used to illustrate the moving objects found by the Applicants' algorithm. FIG. 3 has four moving objects—the truck and car entering the intersection from the bottom of the frame, the van coming to a stop at the traffic light at the top, and the pedestrian near the corner of the building at the top right of the frame. The robust identification of the moving objects obtained by the Applicants' algorithm is further illustrated in FIGS. 4 through 7.

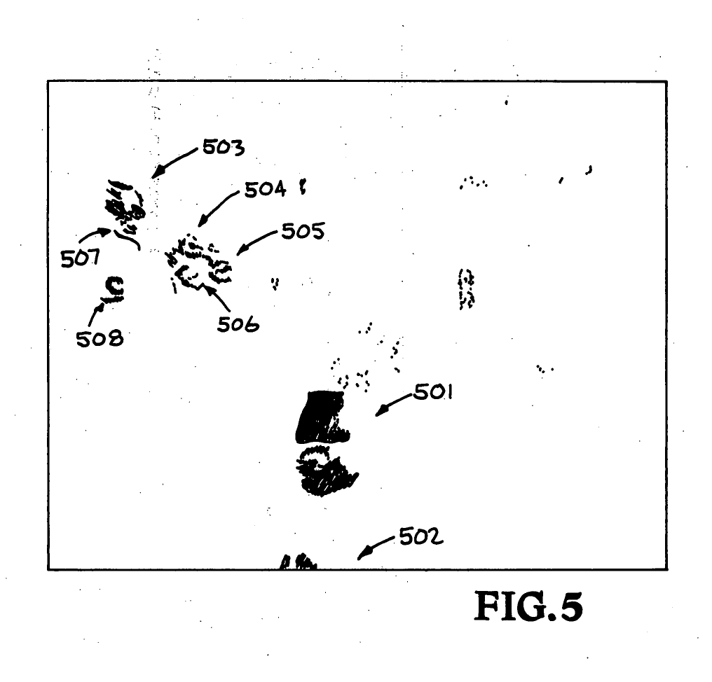

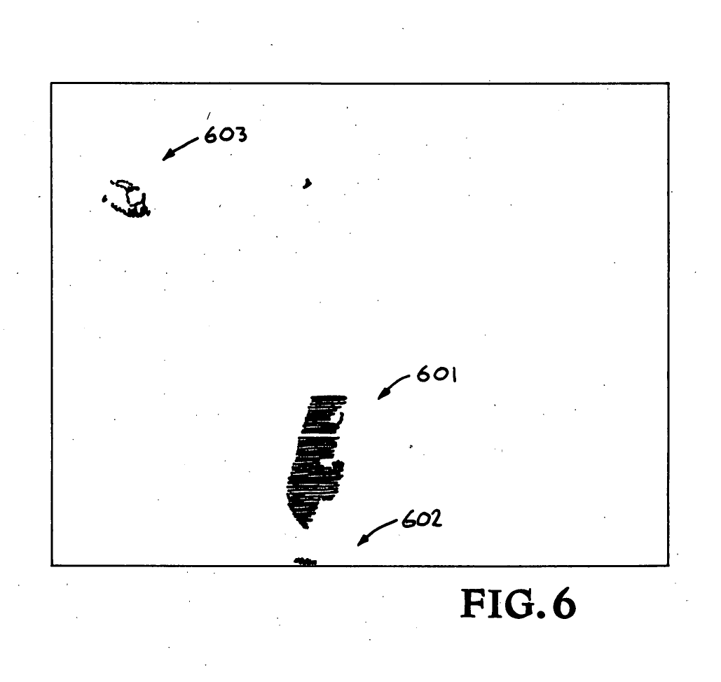

FIGS. 4, 5, and 6 shows moving objects identified by different algorithms using the view of the same traffic intersection as in FIG. 3. FIG. 4 illustrates the moving objects identified by a fast-adapting algorithm. The moving objects identified by a fast-adapting algorithm in FIG. 4 are designated by the reference numerals 401, 402, and 403. FIG. 5 illustrates the moving objects identified by a slow-adapting algorithm. The moving objects identified by a slow-adapting algorithm in FIG. 5 are designated by the reference numerals 501, 502, 503, 504, 505, 506, 507, and 508. FIG. 6 illustrates how the present invention combines the output from the slow- and fast-adapting algorithms to better identify the moving objects. The robust identification of the moving objects obtained by the Applicants' algorithm is designated by the reference numerals 601, 602, 603, and 604.

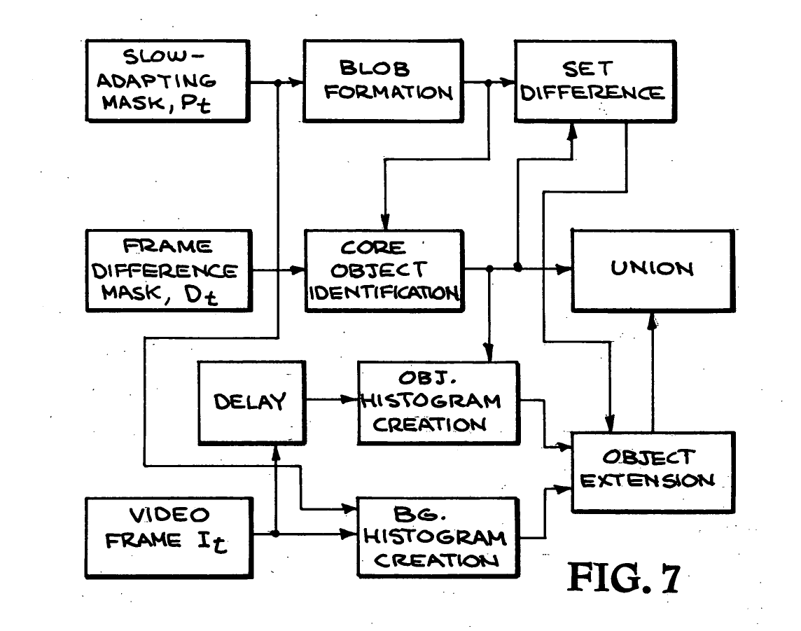

Referring now to FIG. 7, the structure of the data validation module of an embodiment of a system constructed in accordance with the present invention is illustrated. The data validation module is designated generally by the reference numeral 700. The data validation module 700 illustrates Applicants' algorithm for validating a foreground mask computed by a slow-adapting background subtraction algorithm. FIG. 6 is a schematic diagram of Applicants' algorithm. The output is a binary foreground mask Fₜ at time t with Fₜ(p)=1 indicating a foreground pixel detected at location p. There are three inputs to the algorithm: 1) Iₜ is the video frame at time t; 2) Pₜ is the binary foreground mask from a slow-adapting background subtraction algorithm; 3) Dₜ denotes the foreground mask obtained by thresholding on the normal statistics of the difference between Iₜ and Iₜ₋₁ i.e. Dₜ(p)=1 if

$$\frac{\vert {I}_{t} ( p ) - {I}_{t - 1} ( p ) - {μ}_{d} \vert}{{σ}_{d}} > {T}_{d} \qquad ( 1 )$$

and zero otherwise. μ_{d} and σ_{d} are the mean and the standard deviation of Iₜ(q)−Iₜ₋₁(q) for all spatial locations q. Frame-differencing is the ultimate fast-adapting background subtraction algorithm.

There are five key components in Applicants' algorithm: blob formation, core object identification, background histogram creation, object histogram creation, and object extension.

Blob Formation—In blob formation, all the foreground pixels in Pₜ are grouped into disconnected blobs Bₜ⁰, Bₜ¹, . . . , Bₜ^{N} based on the assumption that each foreground pixel is connected to all of its eight adjacent foreground pixels. A blob may contain 1) no object, 2) part of a moving object, 3) a single moving object with possible foreground trail, and 4) multiple moving objects. The first case corresponds to the foreground ghost. The second case is likely the result of the aperture problem. Since Pₜ is computed by a slow-adapting algorithm, the aperture problem occurs only when an object is starting to move. Most blobs fall into the third case of a single object. The last case of multiple objects occurs when multiple vehicles start moving after a traffic light has turned green. Applicants ignore the last case as the large blob is likely to break down into multiple single-object blobs once the traffic disperses. The main goals of Applicants algorithm are 1) to eliminate all the ghost blobs, 2) to maintain the partial-object blobs so that they can grow to contain the full objects, and 3) to produce better localization for single-object blobs by removing any foreground trail. Applicants accomplish these goals by validating each blob with the frame-difference mask Dₜ in the core object identification module.

Core Object Identification—The core object identification module first eliminates all the blobs that do not contain any foreground pixels from Dₜ. This step removes all the ghost blobs which produce no significant frame differences as there are no moving objects in them. The module then computes a core object Oₜⁱ for each of the remaining blobs Bₜⁱ. Oₜⁱ is defined as follows:
Oₜⁱ=bounding ellipse{p:pεBₜⁱ,Dₜ(p)=1}∩Bₜⁱ (2)
The blob contains both the object and its foreground trail. The frame-difference mask Dₜ captures the front part of the object and the small area trailing the object, but completely ignores the rest of the foreground trail of the blob. Taking advantage of the shape of a typical vehicle, Applicants assume that the object is contained within the bounding ellipse of all the foreground pixels from Dₜ inside the blob. The key idea is that Applicants can use the bounding ellipse to exclude most of the foreground trail from the blob. The bounding ellipse is computed by first calculating its two foci and orientation based on the first and second-order moments of the foreground pixels in Dₜ, and then increasing the length of its major axis until it contains all the foreground pixels. Finally, Applicants output the intersection between the bounding ellipse and the blob.

Background Histogram Creation—Applicants' experience with urban traffic sequences indicates that most moving objects can be adequately represented by their corresponding core objects. Nevertheless, there are situations where the core object captures only a small portion of the entire moving object.

Object Histogram Creation and Object Extension—To build the object histogram, Applicants notice that the core object Oₜⁱ, as defined in Equation (2), may contain pixels that are not part of the object. It is shown in that the only pixels guaranteed to be part of the object are pixels from Iₜ₋₁ that are foreground in both Dₜ and Dₜ₋₁. Based on Applicants' experience, this approach does not always produce sufficient number of pixels to reliably estimate the object histogram. Instead, for each core object Oₜⁱ, Applicants first identify the corresponding core object at time t−1, which Applicants denote as Oₜ₋₁ⁱ. Applicants accomplish this by finding the core object at time t−1 that has the biggest overlap with Oₜ₋₁ⁱ. Then, Applicants compute the intersection between Oₜⁱ and Oₜ₋₁ⁱ and build the histogram of the pixels from Iₜ₋₁ under this intersection.

Applicants have introduced a new algorithm to validate foreground regions or blobs captured by a slow-adapting background subtraction algorithm. By comparing the blobs with bounding ellipses formed by frame-difference foreground pixels, the algorithm can eliminate false foreground trails and ghost blobs that do not contain any moving object. Better object localization under occlusion is accomplished by extending the ellipses using the object and background pixel distributions. Ground-truth experiments with urban traffic sequences have shown that Applicants' proposed algorithm produces performances that are comparable or better than other background subtraction techniques.

Once the moving objects have been detected, they can be tracked from one frame to the next, using features extracted to describe the objects in each frame. These features can include the x and y coordinates of the centroid of the object, its size, its color, etc. The tracking can be done using well-known algorithms such as the Kalman filter or motion correspondence. Since the applicants' algorithm gives better localization of the objects, it results in more accurate values for the coordinates of the centroid, the size, and the color of the objects. This results in more accurate tracking.

Identifying moving objects in a video sequence is a fundamental and critical task in video surveillance, traffic monitoring and analysis, human detection and tracking, and gesture recognition in human-machine interface. The present invention utilizes background subtraction, where each video frame is compared against a reference or background model. Pixels in the current frame that deviate significantly from the background are considered to be moving objects. These “foreground” pixels are further processed for object localization and tracking. Background subtraction is the first step in computer vision applications, it is important that the extracted foreground pixels accurately correspond to the moving objects of interest. Requirements of a good background subtraction algorithm include fast adaptation to changes in environment, robustness in detecting objects moving at different speeds, and low implementation complexity.

Referring now to FIG. 8, another embodiment of an apparatus constructed in accordance with the present invention is illustrated. The apparatus is designated generally by the reference numeral 800. The apparatus 800 improves identification of moving objects 801 using a stationary video camera 801 that produces a video sequence 803. A computer 804 processes the video sequence 803. Individual video frames 805 are compared against a reference 806 using algorithms 807. The apparatus 800 separates the moving foreground from the background, extracts features representing the foreground objects, tracks these objects from frame to frame, and post-process the tracks on the display 808.

The apparatus 800 provides robust, accurate, and near-real-time techniques for detecting and tracking moving objects in video from a stationary camera. This allows the modeling of the interactions among the objects, thereby enabling the identification of normal patterns and detection of unusual events. The algorithms 807 and software include techniques to separate the moving foreground from the background, extract features representing the foreground objects, track these objects from frame to frame, and post-process the tracks for the display 808. The apparatus 800 can use video taken under less-than-ideal conditions, with objects of different sizes moving at different speeds, occlusions, changing illumination, low resolution, and low frame rates.

The system 800 improves identification of moving objects in a video sequence. Video frames are compared against a reference or background model. Pixels in the current frame that deviate significantly from the background are considered to be moving objects. These “foreground” pixels are further processed for object localization and tracking. In one embodiment a local motion model is applied to the difference between consecutive frames to produce a map of salient foreground pixels. The foreground is segmented into regions which are used as templates for a normalized correlation based tracker. In one embodiment a slow-adapting background model such as the Kalman filter is combined with a fast-adapting model such as the difference between consecutive frames, and used together with the information in the video frame to produce a robust identification of the moving objects in the frame. In another embodiment, the slow adapting background model can be generated using the Mixtures of Gaussians method.

The apparatus 800 is useful in video surveillance, traffic monitoring and analysis, human detection and tracking, and gesture recognition in human-machine interface. The capability to detect and track in video supports the national security mission by enabling new monitoring and surveillance applications for counterterrorism and counter-proliferation. The algorithms and software are being applied to surveillance video, as well as spatiotemporal data from computer simulations.

Additional information about the present invention is disclosed in the following article: “Robust Techniques for Background Subtraction in Urban Traffic Video,” by Sen-Ching S. Cheung and Chandrika Kamath, IS&T/SPIE's Symposium on Electronic Imaging San Jose, Calif., United States, Jan. 18, 2004 through Jan. 22, 2004. The article “Robust Techniques for Background Subtraction in Urban Traffic Video,” by Sen-Ching S. Cheung and Chandrika Kamath, IS&T/SPIE's Symposium on Electronic Imaging San Jose, Calif., United States, Jan. 18, 2004 through Jan. 22, 2004 is incorporated herein by this reference.

Additional information about the present invention, about Applicants' data validation module, about Applicants' research, about Applicants' tests, about Applicants' test result, and other information is disclosed in the following article: “Robust Background Subtraction with Foreground Validation for Urban Traffic Video,” by Sen-Ching S. Cheung and Chandrika Kamath, EURASIP Journal on Applied Signal Processing (EURASIP JASP), Volume 2005, Number 14, Aug. 11, 2005. The article “Robust Background Subtraction with Foreground Validation for Urban Traffic Video,” by Sen-Ching S. Cheung and Chandrika Kamath, EURASIP Journal on Applied Signal Processing (EURASIP JASP), Volume 2005, Number 14, Aug. 11, 2005, is incorporated herein by this reference.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. A method of improving identification of moving objects in a video comprising the steps of:
obtaining a video sequence that includes the objects, and
using a fast-adapting background subtraction model to validate the results of a slow-adapting background subtraction model to improve identification of the objects.

2. The method of improving identification of moving objects in a video of claim 1 wherein the said fast-adapting algorithm is the difference of two consecutive frames.

3. The method of improving identification of moving objects in a video of claim 1 wherein the said slow-adapting algorithm is the Kalman filter.

4. The method of improving identification of moving objects in a video of claim 1 wherein the said slow-adapting algorithm is Mixtures of Gaussians.

5. The method of improving identification of moving objects in a video of claim 1 wherein the said fast-adapting algorithm is used to validate the results of the slow-adapting algorithm by considering the moving object to be defined by the bounding ellipse around the object identified by the fast-adapting algorithm.

6. The method of improving identification of moving objects in a video of claim 1 wherein the histograms of the object and the background are used to correctly identify moving objects which may be partially occluded.

7. The method of improving identification of moving objects in a video of claim 2 wherein the said slow adapting algorithm is the Kalman filter.

8. The method of improving identification of moving objects in a video of claim 2 wherein the said slow-adapting algorithm is the Mixtures of Gaussians.

9. The method of improving identification of moving objects in a video of claim 7 wherein said fast-adapting algorithm is used to validate the results of the slow-adapting algorithm by considering the moving object to be defined by the bounding ellipse around the object identified by the fast-adapting algorithm.

10. The method of improving identification of moving objects in a video of claim 8 wherein the fast-adapting algorithm is used to validate the results of the slow-adapting algorithm by considering the moving object to be defined by the bounding ellipse around the object identified by the fast-adapting algorithm.

11. The method of improving identification of moving objects in a video of claim 9 wherein the histograms of the object and the background are used to correctly identify moving objects which may be partially occluded.

12. The method of improving identification of moving objects in a video of claim 10 wherein the histograms of the object and the background are used to correctly identify moving objects which may be partially occluded.

13. A method of improving identification of objects in a video comprising the steps of:
obtaining a video sequence that includes the moving objects, and
utilizing an algorithm which combines a slow-adapting background subtraction technique with a fast-adapting background subtraction technique to improve identification of the objects, wherein the said algorithm slow-adapting algorithm is the Kalman filter and the fast-adapting algorithm is the difference of consecutive frames of the video, and
validating the results of the slow adapting algorithm by considering the moving object to be defined by the bounding ellipse around the object identified by the fast-adapting algorithm, and
using the histograms of the object and the background to correctly identify moving objects which may be partially occluded.

14. An apparatus for improving identification of objects in a video, comprising:
a camera that produces a video sequence including the objects; and
a computer adapted to process said video sequence, produce individual frames, and use a fast-adapting background subtraction model to validate the results of a slow-adapting background subtraction model to improve identification of the objects.

15. The apparatus for improving identification of objects in a video of claim 14 wherein said wherein said fast-adapting algorithm is the difference of two consecutive frames.

16. The apparatus for improving identification of objects in a video of claim 14 wherein said wherein said slow-adapting algorithm is the Kalman filter.

17. The apparatus for improving identification of objects in a video of claim 14 wherein said wherein said slow-adapting algorithm is Mixtures of Gaussians.

18. The apparatus for improving identification of objects in a video of claim 16 wherein said fast-adapting algorithm is used to validate the results of the slow-adapting algorithm by considering the moving object to be defined by the bounding ellipse around the object identified by the fast-adapting algorithm.

19. The apparatus for improving identification of objects in a video of claim 16 wherein the histograms of the object and the background are used to correctly identify moving objects which may be partially occluded.

20. The apparatus for improving identification of objects in a video of claim 17 wherein said fast-adapting algorithm is used to validate the results of the slow-adapting algorithm by considering the moving object to be defined by the bounding ellipse around the object identified by the fast-adapting algorithm.

21. The apparatus for improving identification of objects in a video of claim 17 wherein the histograms of the object and the background are used to correctly identify moving objects which may be partially occluded.

22. The apparatus for improving identification of objects in a video comprising:
a camera that produces a video sequence that includes the moving objects; and
a computer adapted to process said video sequence, utilizing an algorithm which combines a slow-adapting background subtraction technique with a fast-adapting background subtraction technique to improve identification of the objects, wherein the said algorithm slow-adapting algorithm is the Kalman filter and the fast-adapting algorithm is the difference of consecutive frames of the video; and
validating the results of the slow adapting algorithm by considering the moving object to be defined by the bounding ellipse around the object identified by the fast-adapting algorithm; and
using the histograms of the object and the background to correctly identify moving objects which may be partially occluded.
